(19) United States
(12) Patent Application Publication
(10) Pub. No.: US 2009/0051654 A1
(43) Pub. Date: Feb. 26, 2009

(54) COMPUTER-MOUSE APPARATUS WITH VOICE-OUTPUT-SWITCH FUNCTION

(75) Inventor: Hua-Wei Wang, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: SYSGRATION LTD., Taipei (TW)

(21) Appl. No.: 11/841,581

(22) Filed: Aug. 20, 2007

(51) Int. Cl. G06F 3/033

(52) U.S. Cl. 345/163

(57) ABSTRACT

A computer-mouse apparatus with voice-output-switch function is provided. In addition to normal functions of a computer-mouse apparatus, this computer-mouse apparatus is configured to make a computer switch a voice output to another voice-output apparatus by using a pre-determined set of buttons on the computer-mouse apparatus. Therefore the user can quickly switch a voice-output of the computer, and improve the conventional operation of changing voice-output apparatus via the computer-control panel.

### BACKGROUND OF THE INVENTION

1. Field of the Invention

The present invention relates to a computer-mouse apparatus with voice-output-switch function, the user can switch the voice output apparatuses by software program and hardware. The present invention simplifies the conventional way that changes voice apparatuses via a computer-control panel.

2. Descriptions of the Related Art

As the electric age quickly advances, periphery appliances of computer diversify and make computer a multimedia tool. As a result, hardware controlled by computer-control panel increase in quantity and become more complex. Generally, a user processes external hardware by plug-and-play method. When the user wants to change original operation mode of the hardware, for example, when the user wants to change the original voice output apparatus, the user has to operate through a computer-control panel, such as Microsoft Windows, Macintosh interface, Linux, etc. The user has to change the original management mode by using the hardware management method of the particular panel to change voice outputs. The aforementioned processes are not user-friendly, and may cause inconvenience when such change is required. Also, such processes increase complexity of using multimedia data.

### SUMMARY OF THE INVENTION

The primary objective of this invention is to provide a computer-mouse apparatus with voice-output-switch function. In addition to normal functions of a typical computer-mouse apparatus, the computer-mouse apparatus is configured to make a computer switch a voice output to another voice-output apparatus by a pre-determined set of buttons of the computer-mouse apparatus. Therefore the user can quickly change the voice-output apparatus of the computer, in comparison with the conventional operation of changing voice-output apparatus via the computer-control panel.

The multimedia functions of the computer are improved and such improvements change conventional life styles. Users have gradually replaced conventional land line phone communication with internet communication. Meanwhile, Skype is greatly popularized and many users install net-phone onto their computers. When there is an incoming call while the user is playing music, the user has to pause or stop the playing music so the net-phone may occupy the original voice output apparatus. The process takes more than several seconds. When the net-phone communication is over, the user has to go to the previous operations to re-play the music. In another situation, a user may use computer speakers as voice output of the net-phone. When the communication involves privacy, the user has to change the original voice output apparatus from the speaker to the Skype phone. This process is also relatively complex. Therefore, when there is an incoming call for the net-phone, the user usually acts with confusion and doesn't know how to efficiently switch voice output to a proper output apparatus.

The present invention provides a computer-mouse apparatus with voice-output-switch function. In addition to normal functions of a computer-mouse apparatus, this computer-mouse apparatus is characterized in being configured to make a computer switch a voice output to another voice-output apparatus by a pre-determined set of buttons of the computer-mouse apparatus.

By pressing the pre-determined set of the buttons of the computer-mouse apparatus, the user can immediately switch the voice output of the computer to a desired voice-output apparatus, and the operation takes very little time, preferably less than half a second. The main objective is to allow a user to quickly change the voice-output apparatus of the computer and increase convenience of using a net-phone.

### BRIEF DESCRIPTION OF THE DRAWINGS

FIG. 1 is a perspective view of the connection of apparatuses of the present invention;

FIG. 2 is a diagram of the switching-voice-apparatus sequence of the computer-mouse apparatus; and

FIG. 3 is a view of the Skype Mouse with Skype-phone function.

### DESCRIPTION OF THE PREFERRED EMBODIMENT

The present invention relates to a computer-mouse apparatus with voice-output-switch function. By utilizing conventional firmware design, a particular control firmware program is brought up and denoted as a voice-output-switch firmware program. The user designs, or pre-programs, pre-determined sets of control, such as, pressing the left button, the right button, rolling a wheel of the computer-mouse apparatus, simultaneously pressing the left button and right button, simultaneously pressing the right button and rolling the wheel, and so forth. When the user presses a set of the computer-mouse apparatus, the voice-output-switch firmware program is activated to control hardware of the computer to switch from an original voice apparatus to another voice-output apparatus. The flow of switching voice outputs by the computer-mouse apparatus with voice-output-switch function comprises the steps of:
(1) pressing a pre-determined set of buttons of the computer-mouse apparatus by an user to trigger the voice-output-switch firmware program to control the computer for executing operation of switching voice outputs;
(2) blocking the original voice circuit first when processing the operation of switching the voice outputs;
(3) inducing voice to an assigned voice-output apparatus for replaying;
(4) switching the voice to a next voice-output apparatus when the pre-determined set of button, or buttons of the computer-mouse apparatus are pressed again by the user via the voice-output-switch firmware program that controls the computer;
(5) switching voice to the original voice apparatus by the computer following a switching-voice-apparatus sequence after user's certain operations of pressing the pre-determined set of buttons of the computer-mouse apparatus.

The voice-output-switch firmware program is made of following the aforementioned steps and is configured to collocate with the pre-determined sets of buttons of the computer-mouse apparatus. More particularly, the pre-determined sets of buttons do not affect original function of the computer-mouse apparatus.

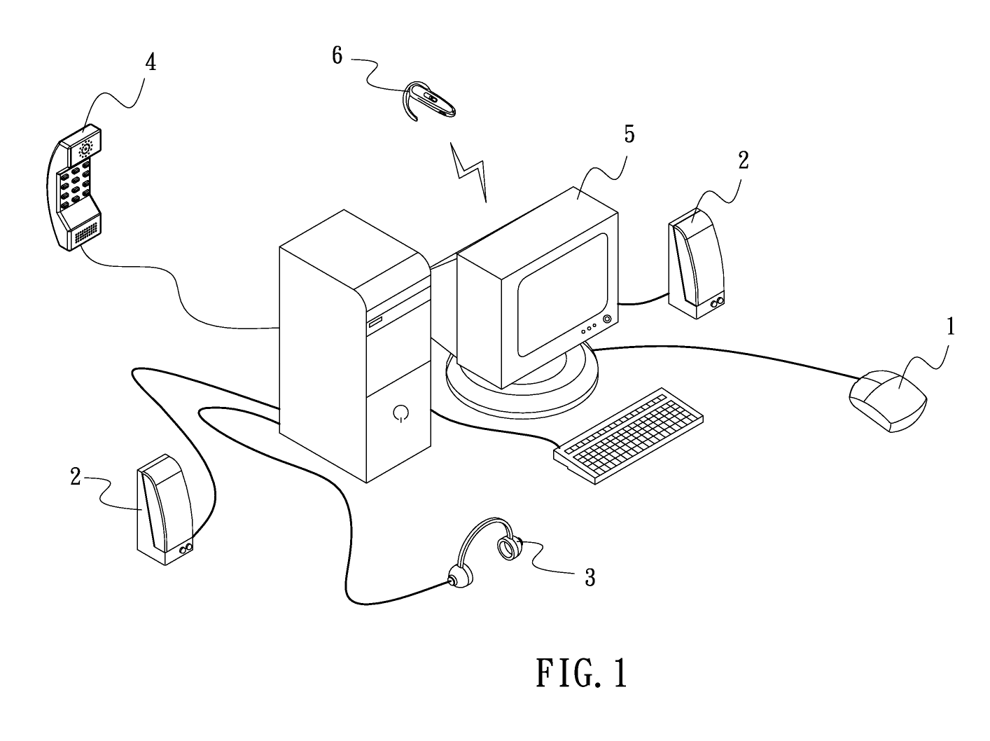

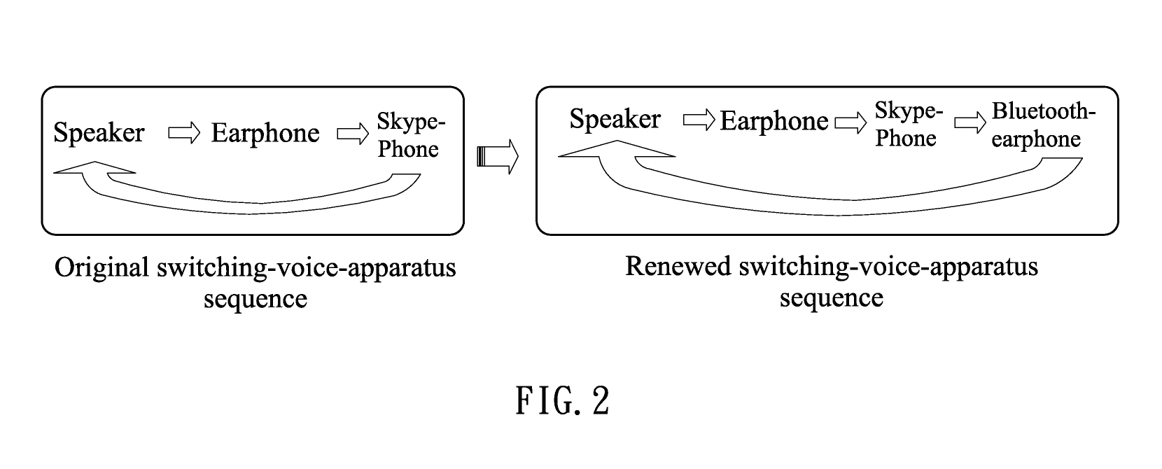

Referring to FIG. 1, a computer system 5 is connected to three voice-output apparatuses, a speaker 2, an earphone 3, and a Skype phone 4. The user presses the pre-determined set of buttons of a computer-mouse apparatus 1 to switch the voice-output apparatus from the speaker 2 to the earphone 3, the user can press the pre-determined set again to switch the voice-output apparatus from the earphone 3 to the Skype phone 4, and the user can press the pre-determined set again to switch the voice-output apparatus from the Skype phone 4 to the speaker 2. It is realized that the switching-voice-apparatus sequence in this embodiment is first the speaker 2, then the earphone 3, then the Skype phone 4, then back to the speaker 2, as shown in FIG. 2.

When a new voice-output apparatus is installed to the computer system, the voice-output-switch firmware program makes hardware of the computer system to automatically detect newly installed voice-output apparatus and automatically renew the switching-voice-apparatus sequence. For example, when a Bluetooth earphone 6 is installed to the computer system 5 as shown in FIG. 1, although the Bluetooth earphone 6 communicates with the computer system 5 via wireless transmission, the voice-output-switch firmware program is still able to renew the switching-voice-apparatus sequence of first the speaker 2, then the earphone 3, then the Skype phone 4, then the Bluetooth earphone 6, then back to the speaker 2 as shown in FIG. 2.

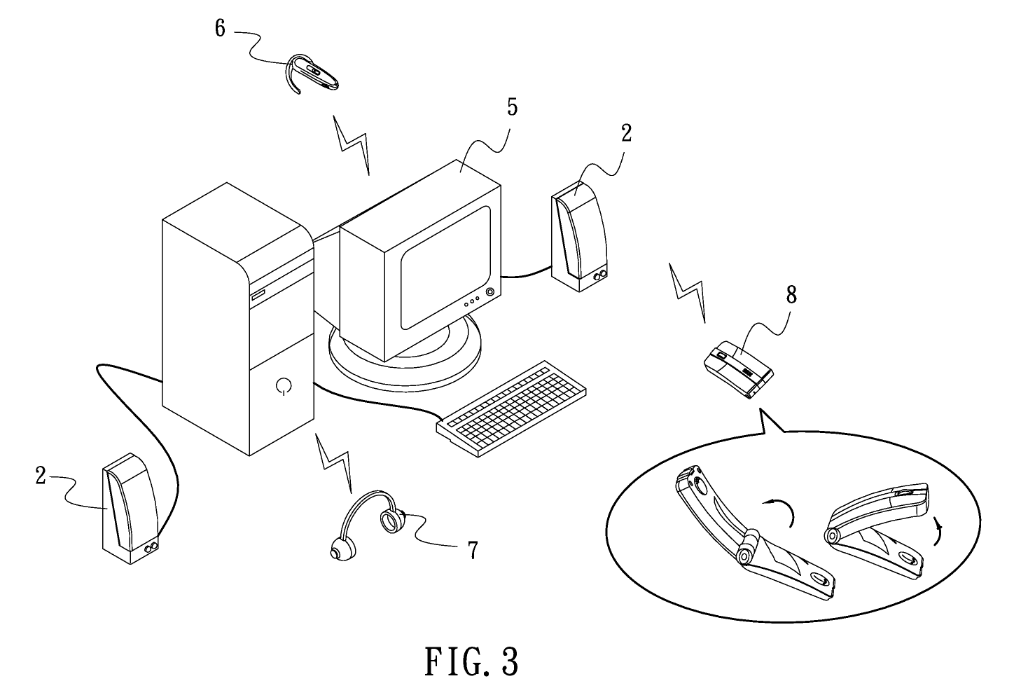

Besides, the voice-output apparatus of the computer system is able to communicate with the computer system via wireless transmission, as shown in FIG. 3, in which the Bluetooth earphone 6, a wireless earphone 7, and even a Skype Mouse 8 with Skype-phone function communicate with the computer system via wireless transmission, and the voice-output-switch firmware program is adapted to switch these wireless voice-output apparatuses between each other via operation of a wireless computer-mouse apparatus.

To make the switching-voice-apparatus sequence more flexible, the voice-output-switch firmware program is designed with a selection menu of voice-output apparatuses, and the selection menu instantaneously pops out to illustrate the present voice-output apparatuses connected to the computer system. The user can then realize the switching-voice-apparatus sequence and the next voice-output apparatus. The user is able to re-configure the switching-voice-apparatus sequence via the selection menu.

In some particular situations, the voice-output-switch firmware program is controlled by an external program to make the voice output automatically switch to the next voice-output apparatus or a particular voice-output apparatus in an assigned situation. For example, when there is a Skype incoming call, the external program contributes the voice-output-switch firmware program to switch voice-output apparatuses, or even switch to the Skepe phone to make the user directly use the Skype phone without pressing the pre-determined set of buttons of the computer-mouse apparatus. In this kind of application, a Skype Mouse with Skype-phone function is considered, as shown in FIG. 3. As long as there is a Skype incoming call, the user directly answer the call by the Skype Mouse and switch the voice output to the Skype Mouse. Moreover, the Skype Mouse is designed as a wireless mouse, and the user can apply wireless Skype communication.

To use the computer-mouse apparatus with voice-output-switch function anywhere, the voice-output-switch firmware program is stored in a programmable memory of the computer-mouse apparatus, and the user can use the computer-mouse apparatus with voice-output-output function when connecting to other computer system. Moreover, the voice-output-switch firmware program is stored in a network server for the user downloading the voice-output-switch firmware program, and upgrading a conventional computer-mouse with voice-output-switch function. The voice-output-switch firmware program is configured to ensure that the user may change original controlling method to switch different hardware via an external program, or modifying the voice-output-switch firmware program.

The aforementioned detailed description is for explaining a particular embodiment of the present invention, and the embodiment is not applied to limit the present invention. The equivalent embodiment of modification after understanding the present invention shall be within the scope of the invention.

As aforementioned, the present invention is novel in technology and advantaged in many effects that the prior arts lack. The present invention conforms to the novelty and non-obviousness of patentability. Please the examiner carefully considering the application of the present invention and allowing the application.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A computer-mouse apparatus with voice-output-switch function, characterized in that the computer-mouse apparatus is configured to execute a voice-output-switch firmware program by pressing a pre-determined set of a left button, a right button, and a wheel of the computer-mouse apparatus, to make a computer switch from an original voice apparatus to another voice-output apparatus.

2. The computer-mouse apparatus with voice-output-switch function as claimed in claim 1, comprising the steps of:
(1) pressing a pre-determined set of buttons of the computer-mouse apparatus by an user to trigger the voice-output-switch firmware program to control the computer to execute operation of switching voice outputs;
(2) blocking the original voice circuit first when processing the operation of switching the voice outputs;
(3) inducing voice to an assigned voice-output apparatus for replaying;
(4) switching the voice to a next voice-output apparatus when the pre-determined set of buttons of the computer-mouse apparatus are pressed again by the user via the voice-output-switch firmware program controlling the computer;
(5) switching the voice to the original voice apparatus by the computer following a switching-voice-apparatus sequence after user's certain operations of pressing the pre-determined set of buttons of the computer-mouse apparatus.

3. The computer-mouse apparatus with voice-output-switch function as claimed in claim 1, wherein the pre-determined set of buttons of the computer-mouse apparatus is a set of general buttons of the computer-mouse apparatus with conventional operations or an additional function key affixed to the computer-mouse apparatus particularly for switching voice outputs.

4. The computer-mouse apparatus with voice-output-switch function as claimed in claim 2, wherein the voice-output-switch firmware program is configured to make the computer instantaneously detect newly installed voice-output apparatus and automatically renew the switching-voice-apparatus sequence.

5. The computer-mouse apparatus with voice-output-switch function as claimed in claim 2, wherein the switching-voice-apparatus sequence is configured to ensure the user re-configure the switching-voice-apparatus sequence via a selection menu.

6. The computer-mouse apparatus with voice-output-switch function as claimed in claim 5, wherein the switching-voice-apparatus menu instantaneously pops out for selection.

7. The computer-mouse apparatus with voice-output-switch function as claimed in claim 1, wherein the voice-output-switch firmware program is controlled by an external program to make the voice output automatically switch to the next voice-output apparatus or a particular voice-output apparatus in an assigned situation.

8. The computer-mouse apparatus with voice-output-switch function as claimed in claim 1, wherein the voice-output-switch firmware program is stored in a programmable memory of the computer-mouse apparatus, in which the voice-output-switch firmware program is available when the computer-mouse apparatus is connected to any computer system.

9. The computer-mouse apparatus with voice-output-switch function as claimed in claim 8, wherein the voice-output-switch firmware program is stored in a network server for the user downloading the voice-output-switch firmware program, and upgrading a conventional computer-mouse with voice-output-switch function.

10. The computer-mouse apparatus with voice-output-switch function as claimed in claim 1, wherein the voice-output-switch firmware program is configured to ensure the user change original controlling method to switch different hardware via an external program or modifying the voice-output-switch firmware program.

11. The computer-mouse apparatus with voice-output-switch function as claimed in claim 1, wherein the computer-mouse apparatus is equipped with Skype phone function and denoted as a Skype Mouse, the user can use the Skype Mouse to answer an internet phone and process switching voice-output-switch function.

12. The computer-mouse apparatus with voice-output-switch function as claimed in claim 11, wherein the computer-mouse apparatus is equipped with Skype phone function.
